(19) United States
(12) Patent Application Publication
(10) Pub. No.: US 2002/0051457 A1
(43) Pub. Date: May 2, 2002

(54) Interception system and method

(76) Inventor: Jaana Eloranta, Helsinki (FI)

Correspondence Address: Michael B. Lasky, Altera Law Group, Suite 100, 6500 City West Parkway, Minneapolis, MN, 55344-7701, US

(21) Appl. No.: 09/952,370

(22) Filed: Sep. 11, 2001

Related U.S. Application Data
(63) Continuation of application No. PCT/EP99/01760, filed on Mar. 12, 1999.

(51) Int. Cl. H04L 12/28

(52) U.S. Cl. 370/401; 370/352

(57) ABSTRACT

An interception method and system for performing a lawful interception in a packet network such as a GPRS network is described, wherein a subscriber identity is allocated to an interceptor, such that the interceptor is treated as a mobile station. Thus, the interception traffic is processed as usual data traffic which can be charged using normal charging procedures and which can be intercepted using the normal lawful interception methods. Accordingly, no additional functions are required for charging and intercepting an interception.

### FIELD OF THE INVENTION

The present invention relates to an interception system and method for performing a lawful interception in a packet network such as the GPRS (General Packet Radio Services) or the UMTS (Universal Mobile Telecommunications System) network.

### BACKGROUND OF THE INVENTION

The provision of a lawful interception is a requirement of national law, which is usually mandatory. From time to time, a network operator and/or a service provider will be required, according to a lawful authorization, to make available results of interception relating to specific identities to a specific interception authority or Law Enforcement Agency (LEA).

There are various aspects of interception. The respective national law describes under what conditions and with what restrictions interception is allowed. If a LEA wishes to use lawful interception as a tool, it will ask a prosecuting judge or other responsible body for a lawful authorization, such as a warrant. If the lawful authorization is granted, the LEA will present the lawful authorization to an access provider which provides access from a user's terminal to that network, to the network operator, or to the service provider via an administrative interface or procedure.

Such a lawful interception functionality is also needed in the packet switched part of new mobile data networks such as the GPRS and the UMTS.

Several approaches have been proposed so far. According to the hub approach, a hub is added to the GPRS backbone, such that all sections will pass through the hub. The benefit of this system is that the SGSN (Serving GPRS Support Node) and the GGSN (Gateway GPRS Support Node) do not have to know anything about the lawful interception functionality. The hub consists of a pseudo GGSN interface and a pseudo SGSN interface, between which a Lawful Interception Node (LIN) is arranged.

According to another so-called SGSN/GGSN approach, the whole interception function is integrated into a combined SGSN/GGSN element. Every physical SGSN/GGSN element is linked by an own interface to an administrative function. The access method for delivering a GPRS interception information is based on a duplication of packets transmitted from an intercepted subscriber via the SGSN/IGGSN element or to another party. The duplicated packets are sent to a delivery function for delivering the corresponding interception information to the LEA.

Still another approach is to provide an interception or sniffer element, such as a LIN, in each network segment of the Ethernet where GPRS data is transferred. The sniffer elements then transmit intercepted data packets to a collecting LIG (Lawful Interception Gateway) network element.

In the above hub, SGSN/GGSN and LIN solutions, the intercepted data is transferred independently using an existing (internal) data network of the network operator. Thus, an independent charging for interception users has to be developed.

Furthermore, an interception of another interception requires an additional method such as auditing a lawful interception gateway machine by an interception supervisor.

Thus, interception charging and interception of interception is so far not possible without extra effort.

### SUMMARY OF THE INVENTION

It is therefore an object of the present invention to provide an interception method and system, by means of which charging and interception of interception can be easily implemented.

This object is achieved by an interception system for performing a lawful interception in a packet network, comprising:

interception activation and deactivation means for allocating a subscriber identity to an interception data destination in response to the receipt of an interception request from an interceptor via a user interface; and interception data collection means for creating a subscriber connection by using said allocated subscriber identity, in response to an interception activation message received from said interception activation and deactivation means, wherein said subscriber connection is used for transmitting intercepted data to said interception destination.

Furthermore, the above object is achieved by an interception method for performing a lawful interception in a packet network, comprising the steps of:

allocating a subscriber identity to an interception data destination in response to an interception request from an interceptor;

creating a subscriber connection by using said allocated subscriber identity; and

using said subscriber connection for transmitting intercepted data to said interception destination.

Accordingly, the intercepted data can be transferred to the interception destination using a normal subscriber connection. In other words, the interception activation and deactivation means is emulated as a mobile station. In this way, the interception activation and deactivation means can be charged using existing packet network charging functions. However, the billing could have totally different billing rules for interception users, although the charging functionality is the same.

Furthermore, the data delivery of intercepted data may also be intercepted, since data and signaling data for an interceptor will be transferred using a usual subscriber connection. In this way, any interceptor can be intercepted.

Preferably, the interception activation and deactivation means are arranged in a legal interception gateway, and the interception data collection means are arranged in a gateway GPRS support node (GGSN), wherein said packet network is a GPRS network. In this case, the subscriber identity is an IMSI address, and the subscriber connection is a GPRS tunnel. The interception data collection means may be arranged to create the GPRS tunnel by updating internal data structures, such as a PDP context, of said gateway GPRS support node.

Thus, it is possible to charge interception authorities based on the amount of intercepted data, similarly to a normal GPRS use. Moreover, since any GPRS connection can be intercepted, a connection carrying intercepted data can be intercepted as well. Thus, legal authorities can supervise each other.

The interception data collection means may be arranged in another GPRS network element and adapted to transmit a PDP context creation message to a gateway GPRS support node in order to create a GPRS tunnel used as the subscriber connection. In this case, the intercepted data can be transferred from the GPRS network element to the gateway GPRS support node by using GTP protocol messages.

Preferably, a plurality of predetermined subscriber identities of the packet network are reserved for the allocation to interception data destinations. In this case, an interception hierarchy may be defined on the predetermined subscriber identities, so as to be used to check whether an interception destination is allowed to intercept an interception data flow to another interception destination.

Furthermore, the subscriber identity can be allocated, when a first interception request is received from the interceptor. The deallocation of the subscriber identity can be performed, when an interception deactivation request has been received.

Preferably, all interception data and control messages are transmitted via the subscriber connection. Furthermore, the subscriber identity may be incorporated in an interception destination information.

### BRIEF DESCRIPTION OF THE DRAWINGS

In the following, the present invention will be described in greater detail on the basis of a preferred embodiment with reference to the accompanying drawings, in which:

FIG. 1 shows a functional block diagram of a lawful interception system according to the present invention,

FIG. 2 shows a: general block diagram of an implementation of a lawful interception system according to the preferred embodiment of the present invention,

FIG. 3 shows a transmission diagram relating to an interception of a tunnel based on an updating of interception parameters according to the preferred embodiment of the present invention, and

FIG. 4 shows a diagram of an implementation of the lawful interception system according to the preferred embodiment in a GPRS network.

### DESCRIPTION OF THE PREFERRED EMBODIMENT

In the following, the preferred embodiment of the system and method according to the present invention will be described on the basis of a GPRS network.

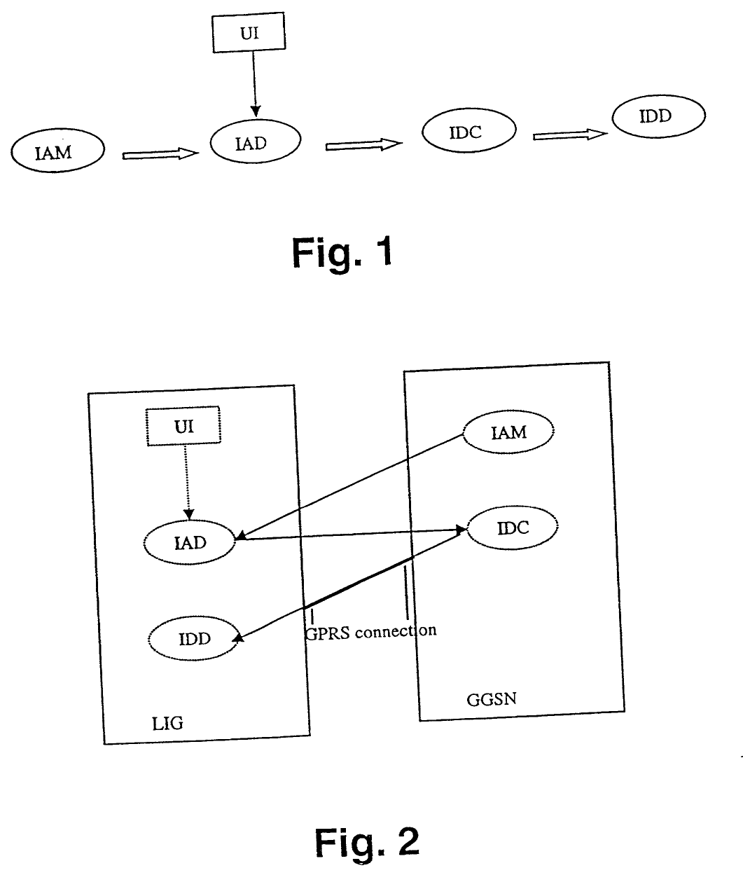

FIG. 1 shows a functional diagram of a lawful interception for a packet network such as the GPRS network. According to FIG. 1, main functional units of the interception system are distinguished, such that an implementation in different real GPRS network elements is possible. According to the preferred embodiment, different implementation possibilities are available, and the most suitable implementation must be selected based on the overall GPRS implementation architecture.

In the following description, a tunnel designates a GTP tunnel between a SGSN and a GGSN, which carries a data packet belonging to one user connection. User data packets are called T-PDUs and are carried in G-PDU packets. A tunnel identifier TID is included in each GTP packet and contains an IMSI (International Mobile Subscriber Identity) number.

A tunnel activation refers to an activation of a tunnel by creating a PDP (Packet Data Protocol) context for a user connection. The SGSN initiates the PDP context creation by sending a Create_PDP_Context_Request message to the GGSN. The GGSN replies by sending a Create_PDP_Context_Response message to the SGSN. After a tunnel is activated, user data is transferred via the tunnel within G-PDU packets, wherein a G-PDU packet contains a GTP header and user data T-PDU.

The tunnel is deactivated by deleting a PDP context earlier created for a user connection. The SGSN initiates the PDP context deletion by sending a Delete_PDP_Context_Request message to the GGSN. The GGSN replies by sending a Delete_PDP_Context_Response message to the SGSN.

The functional diagram shown in FIG. 1 consists of four functional units. An interception activation monitoring function IAM monitors the created and deleted tunnels, in order to gather information about the requirement of activation of any interception in any other functions. Furthermore, an interception activation and deactivation function IAD activates and deactivates the current interception targets, i.e. tunnels, according to an information supplied from the IAM and commands supplied from a user interface UI in order to change interception criteria. Additionally, an interception data collection function IDC is provided, which actually collects the intercepted data transferred in tunnels and forwards it to an interception data destination function IDD which receives the intercepted data, probably post-processes it and forwards it to the final destination which may be a representative of some legal authority or a network operator.

FIG 2 shows a general implementation of the interception system according to the preferred-embodiment in a GPRS network. The IAD and IDD functions are implemented in a LIG network element. Moreover, the IAM and IDC functions are implemented in a gateway GPRS support node GGSN of the GPRS network.

According to the preferred embodiment, intercepted data is transferred from the IDC function to the IDD function by using a normal GPRS connection. Thereby, it is possible to charge authorities based on the amount of intercepted data, similarly to normal GPRS use. Moreover, the GPRS connection can be intercepted as any GPRS connection.

To achieve this, the IAD function is arranged to allocate and deallocate “fake” IMSI numbers or addresses for interceptors. These IMSIs are called IIMSIs (Interceptor IMSIs). These IIMSIs are used for internal GPRS tunnels that transfer intercepted data. The IIMSI is contained in a destination information D transferred between the IAD function, the IDC function and the IDD function.

The IAD comprises an interception database which contains the IIMSIs besides additional interception criteria. The destination D should uniquely identify an interceptor and its data destination.

In general, the network element including the IAD function can be located either at the network operator's site or at the interception authority's site. In the latter case, the interception authority has total management of it. A problem arises, if several interception authorities manage their own IAD functions. Namely, because it is possible to intercept any interception, an interception authority owning an IAD function could intercept any other interception authority's interceptions. This problem can be solved by defining an interception hierarchy on the IIMSI numbers.

For instance, if IMSIs 001-100 are totally reserved to be used as IIMSIs, then the IAD function can be implemented such that only the numbers 001-020 may intercept the numbers 21-100. The numbers 021-040 may then be only allowed to intercept the numbers 040-100, but not the numbers 001-039. Strict hierarchy is needed in order to avoid loops in case LEAs are spying each others. The checking operation whether an IIMSI is able to intercept another IIMSI can be implemented in the IDC function which is always located at the network operator's site.

FIG. 3 shows a transmission diagram of the transmission of data and messages between the above-mentioned functional units, wherein the transmission operation starts at the top of the diagram and moves to the bottom.

The IAM function informs the IAD function of an activated tunnel. However, as long as no interception activation message has been transmitted from the IAD function to the IDC function, an interception and collection of the intercepted data is not performed in the IDC function. Thus, the first G-PDU packet in FIG. 3 of the activated tunnel TID is not transferred to the IDD function.

Then, an interception activation message is received by the IAD function from the user interface UI. In response to this interception activation message, the IAD function transmits an interception activation message comprising an activation criterion and the allocated IIMSI to the IDC function. In response thereto, the IDC function transmits an activation message comprising the tunnel identification TID and a destination information D comprising the IIMSI to the IDD function, for each tunnel with identifier TID where criterion matches the TID. The criterion can be e.g. an IMSI number, wherein the IDC activates data collection for all tunnels with identifier TID such that TID contains this IMSI. If a G-PDU packet relating to the corresponding tunnel TID is then received by the IDC function, it is collected and transmitted to the IDD function together with the tunnel identification TID and the destination D.

If a deactivation message is received by the IAD from the user interface UI, a corresponding deactivation message is transferred to the IDC function. The IDC then transmits a deactivation message for each tunnel TID which matches the given criterion to the IDD, so as to deactivate the interception operation for this tunnel. The IIMSI is deallocated when a deactivation request for all tunnels of the destination D is received via the user interface UI.

While IIMSI is allocated for an interceptor, several activation and deactivation requests may occur. These requests use the existing IIMSI in the messages transmitted to the IDC function. Similarly, the IAD function passes activation requests to the IDC function every time a tunnel is activated, which should be intercepted using the destination D containing the IIMSI. The tunnel deactivation messages transmitted to the IDD function also contain the IIMSI, since one IDD may receive data for several interception authorities.

The IDC function is the functional unit which actually collects the intercepted data. Thus, the IDC function has to create and delete a GPRS tunnel for the intercepted data transfer from the IDC function to the IDD function. Then, all data and control messages should be transmitted via this GPRS tunnel, instead of the usual data transfer. Accordingly, the IDC function has to know the IIMSI number for each intercepted tunnel.

A GPRS tunnel from the IDC function to the IDD function is created either when an interception activation message for a newly generated tunnel or an activation message for a changed interception criterion is received from the IAD, provided that no GPRS tunnel for which an IIMSI already exists is concerned. The GPRS tunnel is deleted when a deactivation message for all interceptions for a destination D is received. Before the tunnel deletion, a corresponding deactivation notification should be transmitted to the IDD function.

As already mentioned, the IDC function has to know the IIMSI for each intercepted tunnel. Then, all intercepted data for this tunnel are transmitted to the correct IDD function using this IIMSI. It is to be noted that also the IDD function knows the IIMSI for each transmitted message, because GTP messages which contain the IIMSI are used for data transfer.

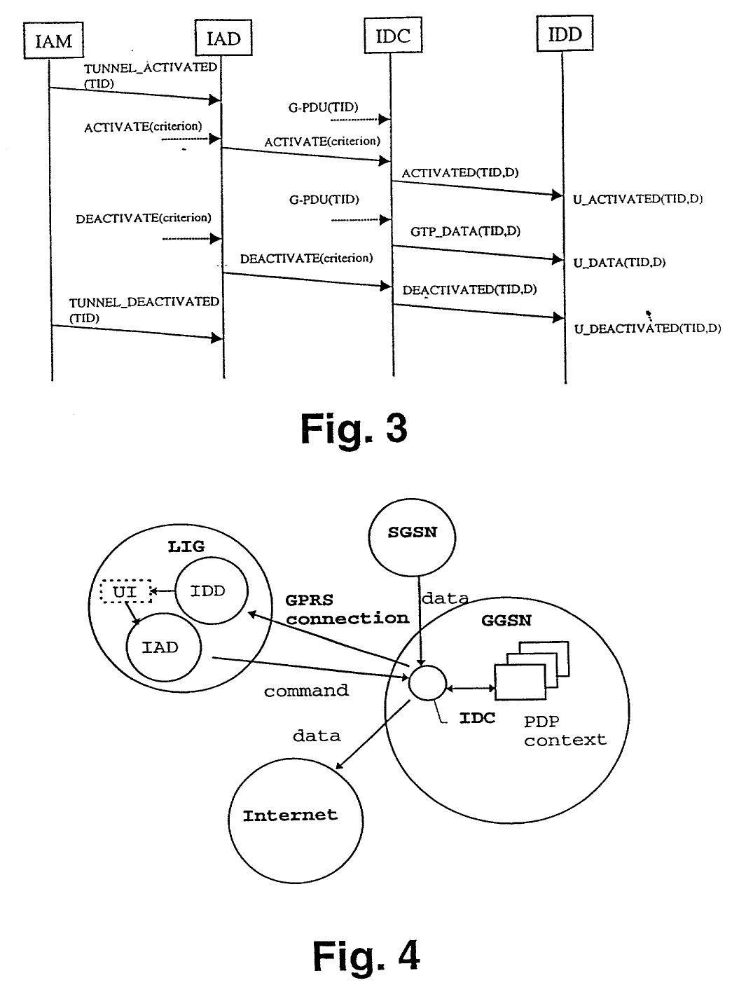

FIG. 4 shows an implementation of the interception system according to the preferred embodiment, wherein the IDC function is implemented in a gateway GPRS support node, in line with FIG. 2. In this case, activation and deactivation of the GPRS tunnels can be implemented by updating internal data structures such as a PDP context stored in the GGSN.

If the IDC function is implemented in another GPRS network element, it has to transmit a PDP_Context_Create or PDP_Context_Delete message to the GGSN, i.e. it emulates an SGSN tunnel activation or deactivation.

The IDC function in the GGSN receives a G-PDU (TID) data packet, in case a data is originally transferred in an intercepted tunnel, e.g. from an SGSN to the Internet, as shown in FIG. 4. The intercepted data is transferred via the just created GPRS tunnel to the IDD function arranged in the LIG. The intercepted data is forwarded with the IIMSI. If the IDC is not included in the GGSN, e.g. in a SGSN, the intercepted data has to be transferred to the GGSN using GTP protocol messages.

The IDD function in the LIG receives the intercepted data and transmits it via the user interface UI to the interceptor to which the IIMSI is allocated.

In order to deliver intercepted data, the IDD function in the LIG just collects all intercepted data belonging to one destination GPRS tunnel based on the IIMSI which identifies the interceptor. Thereafter, the IDD function post-processes the data, removes GTP headers and post-processes data further e.g. on the basis of instructions received from the interceptor, and delivers the data to its final destination, e.g. the user interface UI. The IDD function may collect intercepted data for several interceptors simultaneously. However, there may also be private IDD functions which serve only one interceptor at a time; in this case, IDD should be implemented as a separate network element.

Thus, the preferred embodiment of the present invention presents a general and easy solution for charging and intercepting interceptions.

It is to be noted that the present invention is not limited to the described GPRS network and can be used in any packet network using a subscriber identity for creating a subscriber connection. Thus, the above description of the preferred embodiment and the accompanying drawings are only intended to illustrate the present invention. The preferred embodiment of the invention may vary within the scope of the attached claims.

In summary, an interception method and system for performing a lawful interception in a packet network such as a GPRS network is described, wherein a subscriber identity is allocated to an interceptor, such that the interceptor is treated as a mobile station. Thus, the interception traffic is processed as usual data traffic which can be charged using normal charging procedures and which can be intercepted using the normal lawful interception methods. Accordingly, no additional functions are required for charging and intercepting an interception.

1. An interception system for performing a lawful interception in a packet network, comprising:
a) interception activation and deactivation means (JAD) for allocating a subscriber identity to an interception data destination (IDD); and
b) interception data collection means (IDC) for creating a subscriber connection by using said allocated subscriber identity, in response to an interception activation message received from said interception activation and deactivation means (TAD), wherein said subscriber connection is used for transmitting intercepted data to said interception destination (IDD).

2. An interception system according to claim 1, wherein said subscriber identity is allocated in response to the receipt of an interception request from an interception authority via a user interface (UI).

3. An interception system according to claim 1 or 2, wherein said packet network is a GPRS network, said interception activation and deactivation means (AD) are arranged in a legal interception gateway (LIG), and said interception data collection means (IDC) are arranged in a gateway GPRS support node (GGSN).

4. An interception system according to claim 3, wherein said subscriber identity is an IMSI number and said subscriber connection is a GPRS tunnel.

5. An interception system according to claim 4, wherein said interception data collection means (IDC) is arranged to create said GPRS tunnel by updating internal data structures of said gateway GPRS support node (GGSN).

6. An interception system according to claim 5, wherein said internal data structure is a PDP context.

7. An interception system according to claim 1, wherein said interception data collection means (IDC) is arranged in a GPRS network element and adapted to transmit a PDP context creation message to a gateway GPRS support node (GGSN) in order to create a GPRS tunnel used as said subscriber connection.

8. An interception system according to claim 7, wherein said intercepted data are transferred from said GPRS network element to said gateway GPRS support node by using GTP protocol messages.

9. A network element for a packet network, comprising:
a) interception activation and deactivation means (AD) for allocating a subscriber identity to an interception data destination (IDD); and
b) message generation means for generating an interception activation message comprising said subscriber identity and supplying said interception activation message to another network element (GGSN) having an interception data collection function.

10. A network element according to claim 9, wherein said subscriber identity is allocated in response to the receipt of an interception request from an interception authority via a user interface (UI).

11. A network element according to claim 9 or 10, wherein said network element is a lawful interception gateway (LIG) and said another network element is a gateway GPRS support node (GGSN).

12. A network element for a packet network, comprising:
a) interception data collection means (IDC) for creating a subscriber connection by using a subscriber identity allocated to an interception destination (IDD), in response to an interception activation message received from another network element (LIG) having an interception activation and deactivation function, said interception activation message comprising said subscriber identity; and
b) transmitting means for transmitting collected intercepted data to said interception destination (IDD) via said subscriber connection.

13. A network element according to claim 12, wherein said network element is a gateway GPRS support node (GGSN) and said another network element is a lawful interception gateway (LIG).

14. An interception method for performing a lawful interception in a packet network, comprising the steps of:
a) allocating a subscriber identity to an interception data destination (IDD);
b) creating a subscriber connection by using said allocated subscriber identity; and
c) using said subscriber connection for transmitting intercepted data to said interception destination (IDD).

15. An interception method according to claim 14, wherein said subscriber identity is allocated in response to an interception request from an interceptor.

16. An interception method according to claim 14 or 15, wherein a plurality of predetermined subscriber identities of said packet network are reserved for the allocation to interception data destinations.

17. An interception method according to claim 16, wherein an interception hierarchy is defined on said predetermined subscriber identities, said interception hierarchy being used to check whether an interception destination is allowed to intercept an interception data flow to another interception destination.

18. An interception method according to any one of claims 14 to 17, wherein said subscriber identity is allocated when a first interception request is received from said interceptor.

19. An interception method according to any one of claims 14 to 18, wherein said subscriber identity is deallocated when an interception deactivation request has been received.

20. An interception method according to any one of claims 14 to 19, wherein all interception data and control messages are transmitted via said subscriber connection.

21. An interception method according to any one of claims 14 to 20, wherein said subscriber identity is included in an interception destination information.

22. An interception method according to any one of claims 14 to 21, wherein said subscriber identity is an IMSI address of a GPRS network, and said subscriber connection is a GPRS tunnel of said GPRS network.
